(19) United States
(12) Patent Application Publication
(10) Pub. No.: US 2026/0142542 A1
(43) Pub. Date: May 21, 2026

(54) Linear Motor

(71) Applicant: AAC Microtech (Changzhou) Co., Ltd., Changzhou City (CN)

(72) Inventors: Weibo Chen, Changzhou (CN); Peng Cai, Changzhou (CN); Xiaorong Zhou, Changzhou (CN); Junsheng Wang, Changzhou (CN)

(21) Appl. No.: 19/036,017

(22) Filed: Jan. 24, 2025

Related U.S. Application Data
(63) Continuation of application No. PCT/CN2024/133483, filed on Nov. 21, 2024.

(51) Int. Cl. H02K 33/18

(52) U.S. Cl. CPC H02K 33/18

(57) ABSTRACT

The present invention provides a linear motor includes a housing, a stator connected to the housing, a vibrator. The stator includes a coil and a copper sheet. The vibrator includes a weight, a first and a second magnet assemblies. The weight locates between the coil and the copper sheet. The weight includes an upper and a lower surface. A part of the upper surface recesses to form a first groove, a part of the lower surface recesses to form a second groove not communicated with the second groove. The first magnet assembly locates in the first groove, the second magnet assembly locates in the second groove. The coil cooperates with the second magnet assembly to drive the vibrator to vibrate along an X-axis direction. The linear motor of the present invention has high space utilization and improved the performance.

### FIELD OF THE PRESENT INVENTION

The present invention relates to the field of motor, and more particularly, to a linear motor.

### DESCRIPTION OF RELATED ART

Linear motors are the device that directly convert electrical energy into mechanical energy for linear motion. Linear motors are widely used in various devices that require linear motion.

In related art, in linear motor technology, a conventional linear motor usually includes a housing with a containment space, a vibration unit and a copper sheet located in the containment space, an elastic member that fixes and suspends the vibration unit in the containment space, and a coil assembly fixed to the housing. The vibration unit includes a weight, a pole plate, and a magnet. The coil assembly includes a coil and an iron core. The pole plate is set between the magnet and copper sheet. A magnetic field generated by the coil interacts with the magnetic field generated by the vibration unit to drive the vibration unit to perform reciprocating linear motion. However, after setting the pole plate between the magnet and copper sheet, there will be a large gap between the magnet and copper sheet, which occupies a large storage space. This will be detrimental to the miniaturization and integration of linear motors. At the same time, it limits the size of the weigh, resulting in a decrease in the vibration performance and response speed of the motor.

Therefore, it is desired to provide a new linear motor which can overcome the above problems.

### SUMMARY

In view of the above, the embodiments of the present invention provide a new linear motor having high space utilization and improved the performance.

The present invention provides a linear motor includes a housing having a receiving room, a stator accommodated in the receiving room, a vibrator accommodated in the receiving room, and at least one elastic member connected to the housing and suspending the vibrator in the receiving room. The stator is fixedly connected to the housing. The stator includes a coil and a copper sheet. The vibrator includes a weight, a first magnet assembly, and a second magnet assembly. The weight locates between the coil and the copper sheet. The weight includes an upper surface and a lower surface opposite to the upper surface. A part of the upper surface recesses inwardly to form a first groove, and a part of the lower surface recesses inwardly to form a second groove. The first groove is not communicated with the second groove. The first groove is arranged between the copper sheet and the second groove. The first magnet assembly locates in the first groove, the second magnet assembly locates in the second groove. The coil cooperates with the second magnet assembly to drive the vibrator to vibrate along an X-axis direction.

As an improvement, the first magnet assembly comprises at least one magnet unit, and the second magnet assembly comprises two first magnets and one second magnet located between the two first magnets.

As an improvement, the magnet unit comprises one third magnet, the third magnet having two magnetized regions along the X-axis direction, each magnetized region being magnetized along a Y-axis direction, and a magnetization direction of one magnetized region being opposite to a magnetization direction of the other magnetized region.

As an improvement, the magnet unit comprises two fourth magnets, both the fourth magnets being magnetized along a Y-axis direction, and a magnetization direction of one fourth magnet being opposite to a magnetization direction of the other fourth magnet.

As an improvement, the magnet unit comprises five or seven fifth magnets.

As an improvement, the magnet unit comprises two sixth magnets and one seventh magnet located between the two sixth magnets, both the sixth magnets being magnetized along a Y-axis direction, a magnetization direction of one sixth magnet being opposite to the magnetization direction of the other sixth magnet, the seventh magnet being magnetized along the X-axis direction, the two first magnets being magnetized along the Y-axis direction, the magnetization direction of one first magnet being opposite to the magnetization direction of the other first magnet, the second magnet being magnetized along the X-axis direction, the magnetization direction of each first magnet being the same as the magnetization direction of the corresponding sixth magnet, and the magnetization direction of the second magnet being opposite to the magnetization direction of the seventh magnet.

As an improvement, a size of the first magnet is different from the size of the sixth magnet, and the size of the second magnet is different from the size of the seventh magnet.

As an improvement, a size of the first magnet assembly is different from the size of the second magnet assembly.

As an improvement, an extension direction of the magnet unit is perpendicular to the extension direction of the first magnets, and the first magnets are parallel to the second magnet.

As an improvement, the linear motor further comprises a pole plate between the first magnet assembly and the second magnet assembly, the pole plate connected with the weight.

As an improvement, two ends of the pole plate are welded to the weight, or two ends of the pole plate are glued to the weight.

As an improvement, the pole plate locates in the first groove, and/or the pole plate locates in the second groove, the first magnet assembly spaced apart from the second magnet assembly through the pole plate.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a linear motor in accordance with the first embodiment of the present invention.

FIG. 2 is an exploded view of the linear motor of FIG. 1.

FIG. 3 is an illustrative cross-sectional view of the first embodiment of the linear motor taken along line A-A of FIG. 1.

FIG. 4 is an illustrative cross-sectional view of the second embodiment of the linear motor.

FIG. 5 is an illustrative cross-sectional view of the third embodiment of the linear motor.

FIG. 6 is an illustrative cross-sectional view of the fourth embodiment of the linear motor.

FIG. 7 is a partially assembly view of some members of the fifth embodiment of the linear motor.

FIG. 8 is an illustrative cross-sectional view of the sixth embodiment of the linear motor.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

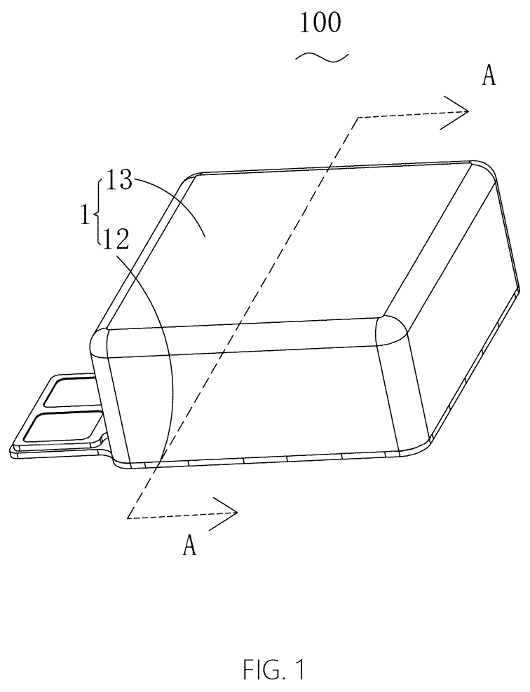

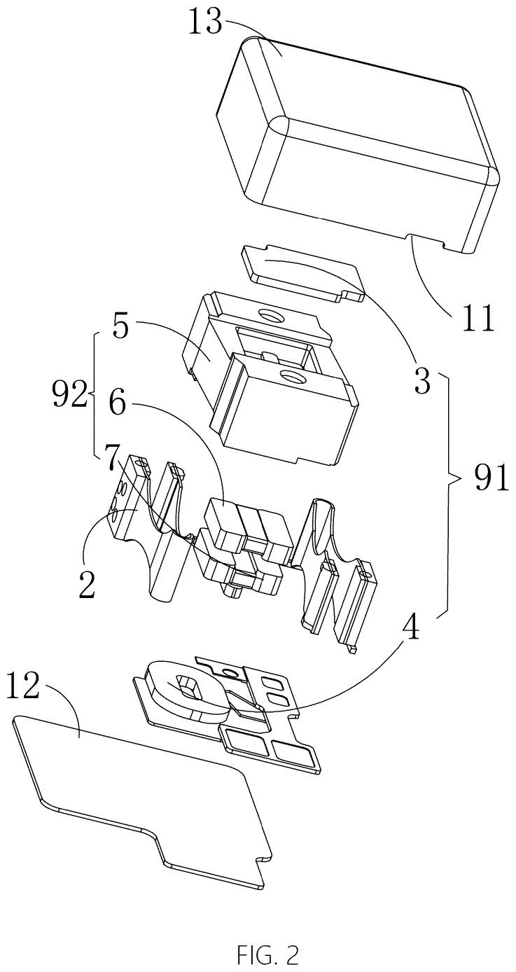

Referring to the FIGS. 1-3, the present invention provides a first embodiment of a linear motor 100. The linear motor 100 includes a housing 1 having a receiving room 11, a stator 91 accommodated in the receiving room 11, a vibrator 92 accommodated in the receiving room 11, and at least one elastic member 2 connected to the housing 1 and suspending the vibrator 92 in the receiving room 11. The stator 91 is fixedly connected to the housing 1. In this embodiment, an amount of the elastic members 2 is two.

The stator 91 includes a copper sheet 3 and a coil 4. The vibrator 92 includes a weight 5, a first magnet assembly 6, and a second magnet assembly 7. The elastic members 2, the copper sheet 3, the coil 4, the weight 5, the first magnet assembly 6, and the second magnet assembly 7 are all received in the receiving room 11. The weight 5 is connected with the elastic members 2. The weight 5 locates between the coil 4 and the copper sheet 3.

The weight 5 includes an upper surface 501 and a lower surface 502 opposite to the upper surface 501. A part of the upper surface 501 recesses inwardly to form a first groove 51, and a part of the lower surface 502 recesses inwardly to form a second groove 52. The first groove 51 is not communicated with the second groove 52. The first groove 51 is arranged between the copper sheet 3 and the second groove 52. The first magnet assembly 6 locates in the first groove 51, and the second magnet assembly 7 locates in the second groove 52. The coil 4 cooperates with the second magnet assembly 7 to drive the vibrator 92 to vibrate along an X-axis direction.

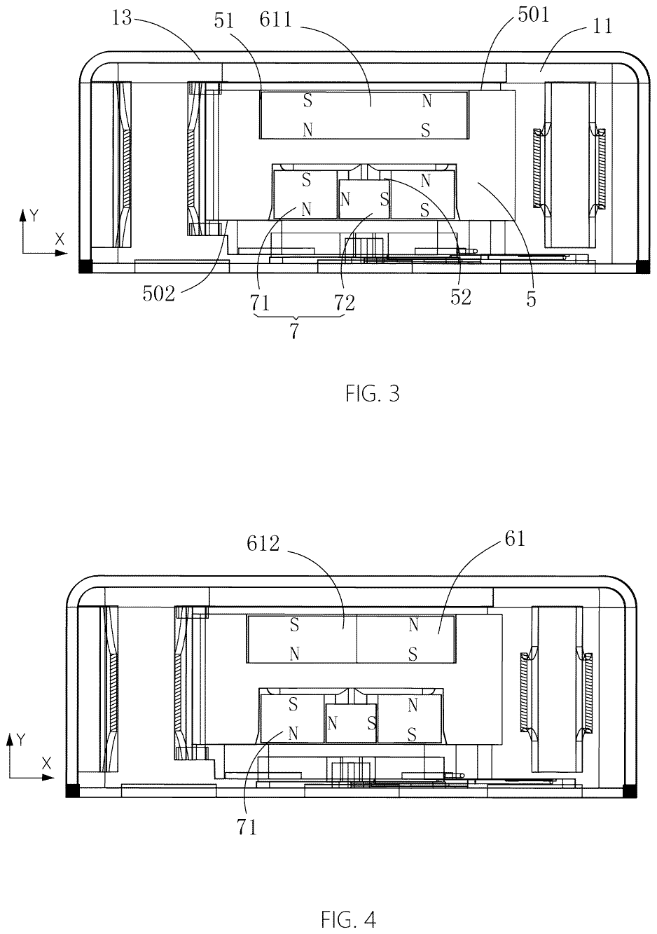

Referring to the FIGS. 1-3, the elastic members 2 suspends the weight 5 in the receiving room 11. The copper sheet 3 is located above weight 5, and the coil 4 is located below weight 5. The housing 1 includes a lower plate 12 and an upper housing 13. The upper housing 13 cooperates with the lower plate 12 to form the receiving room 11. The X-axis direction and a Y-axis direction of the linear motor 100 provided by the embodiment of the present invention are shown in FIG. 3.

An interior of the first groove 51 has a space to accommodate the first magnet assembly 6, and the interior of the second groove 52 has a space to accommodate the second magnet assembly 7. The first magnet assembly 6 is located between the second magnet assembly 7 and copper sheet 3. The second magnet assembly 7 is located between the first magnet assembly 6 and the coil 4. After placing the first magnet assembly 6 inside the first groove 51 and the second magnet assembly 7 inside the second groove 52, there is a small gap between the first magnet assembly 6 and the copper sheet 3 fixed to the upper housing 13, which can reduce the space occupied by internal components. This is beneficial for the miniaturization and integration of linear motor 100, as well as providing a larger installation space for the weight 5 and increasing the weight of the weight 5.

In this embodiment, the stator 91 is fixedly connected to housing 1, and the vibrator 92 is connected to housing 1 and is suspended in receiving room 11 through the elastic members 2. The first magnet assembly 6 and the second magnet assembly 7 are respectively set in the first groove 51 and the second groove 52. Removing the pole plate between the first magnet assembly 6 and the copper sheet 3 will directly reduce the gap between the first magnet assembly 6 and the copper sheet 3. Using smaller volumes of the first magnet assembly 6 and the second magnet assembly 7 can meet the performance requirements, while it also can improve the utilization rate of the magnetic field, increasing the weight of the weight 5, and achieving overall performance improvement of the linear motor 100. Therefore, the present invention improves the space utilization of linear motor 100 and enhances performance of linear motor 100.

A size of the first magnet assembly 6 is different from the size of the second magnet assembly 7. And in other embodiments, the size of the first magnet assembly 6 can be same as the size of the second magnet assembly 7.

In some embodiments, the first magnet assembly 6 includes one or more magnet units 61. The second magnet assembly 7 includes two first magnets 71 and one second magnet 72 located between the two first magnets 71. The magnetic poles of the first magnets 71 are opposite to the magnetic poles of the corresponding magnet unit 61. The magnetic pole of one end of the second magnet 72 proximal to one first magnet 71 is opposite to the magnetic pole of the other end of the second magnet 72 proximal to the other first magnet 71. The second magnet assembly 7 may locates under the first magnet assembly 6. The magnet units 61 can be arranged alternately according to magnetic poles.

In the first embodiment, referring to the FIG. 3, the magnet unit 61 includes one third magnet 611. The third magnet 611 has two magnetized regions along the X-axis direction. Each magnetized region is magnetized along the Y-axis direction, and a magnetization direction of one magnetized region is opposite to a magnetization direction of the other magnetized region. The magnetic pole of one end of third magnet 611 proximal to one first magnet 71 is opposite to the magnetic pole of the other end of third magnet 611 proximal to the other first magnet 71. That is, the third magnet 611 is realized by a piece of magnet with multi-stage magnetization. For example, the magnetic pole of one end of third magnet 611 proximal to one first magnet 71 is the N pole, while the magnetic pole of the other end of third magnet 611 proximal to the other first magnet 71 is the S pole. The N pole and the S pole are disposed on a same side of the third magnet 611. Or the magnetic pole of one end of third magnet 611 proximal to one first magnet 71 is the S pole, while the magnetic pole of the other end of third magnet 611 proximal to the other first magnet 71 is the N pole.

In the second embodiment, referring to the FIG. 4, the magnet unit 61 includes two fourth magnets 612. Both the fourth magnets 612 are magnetized along the Y-axis direction, and the magnetization direction of one fourth magnet 612 is opposite to the magnetization direction of the other fourth magnet 612. The magnetic pole of one end of the fourth magnets 612 proximal to one first magnet 71 is opposite to magnetic pole of one end of the other fourth magnet 612 proximal to the other first magnet 71. For example, the magnetic pole of one end of one forth magnet 612 proximal to one first magnet 71 is the N pole, while the magnetic pole of one end of the other forth magnet 612 proximal to the other first magnet 71 is the S pole. Or the magnetic pole of one end of one forth magnet 612 proximal to one first magnet 71 is the S pole, while the magnetic pole of one end of the other forth magnet 612 proximal to the other first magnet 71 is the N pole.

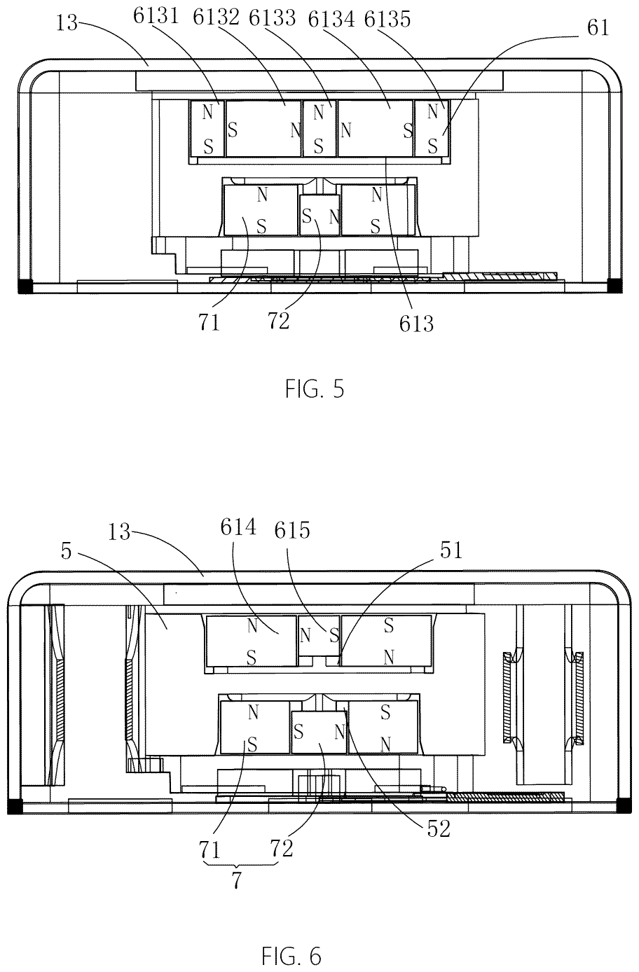

In the third embodiment, referring to the FIG. 5, the magnet unit 61 includes five fifth magnets 613. And in other embodiments, the magnet unit 61 may include seven fifth magnets. Starting from the edge of the magnet unit 61, the fifth magnets 613 located in odd numbered positions are magnetized in the Y direction, and the fifth magnets 613 located in even numbered positions are magnetized in the X direction. In this embodiment, when the magnet unit 61 includes five fifth magnets 613, the five fifth magnets 613 from left to right are the fifth magnet 6131, the fifth magnet 6132, the fifth magnet 6133, the fifth magnet 6134, and the fifth magnet 6135. The fifth magnet 6132 and the fifth magnet 6134 are magnetized along the X-axis direction, and the magnetic pole of fifth magnet 6132 is opposite to magnetic pole of one end of the fifth magnet 6134. For example, the magnetic pole of one end of one fifth magnet 6132 proximal to the fifth magnet 6131 is the S pole, the magnetic pole of one end of one fifth magnet 6132 proximal to the fifth magnet 6133 is the N pole, the magnetic pole of one end of one fifth magnet 6134 proximal to the fifth magnet 6133 is the N pole, the magnetic pole of one end of one fifth magnet 6134 proximal to the fifth magnet 6135 is the S pole. The fifth magnets 6131, 6133, 6135 are magnetized along the Y-axis direction, and the magnetic pole of adjacent fifth magnets 6131, 6133, 6135 have the same magnetization. The magnetic poles of ends of the fifth magnets 6131, 6133, 6135 proximal to the copper sheet 3 are all the same. For example, the magnetic poles of ends of the fifth magnets 6131, 6133, 6135 proximal to the copper sheet 3 are the N pole, while the magnetic poles of the other ends of the fifth magnets 6131, 6133, 6135 distal to the copper sheet 3 are the S pole.

In the fourth embodiment, referring to the FIG. 6, the magnet unit 61 includes two sixth magnets 614 and one seventh magnet 615 located between the two sixth magnets 614. Both the sixth magnets 614 are magnetized along the Y-axis direction, and the magnetization direction of one sixth magnet 614 is opposite to the magnetization direction of the other sixth magnet 614. The seventh magnet 615 is magnetized along the X-axis direction. At the same time, the two first magnets 71 are magnetized along the Y-axis direction, and the magnetization direction of one first magnet 71 is opposite to the magnetization direction of the other first magnet 71. The second magnet 72 is magnetized along the X-axis direction. The magnetization direction of each first magnet 71 is the same as the magnetization direction of the corresponding sixth magnet 614, and the magnetization direction of the second magnet 72 is opposite to the magnetization direction of the seventh magnet 615. That is, the magnetization direction of one first magnet 71 is the same as the magnetization direction of the sixth magnet 614 facing to the corresponding first magnet 71, and the magnetization direction of the other first magnet 71 is the same as the magnetization direction of the sixth magnet 614 facing the corresponding first magnet 71.

Referring to the FIG. 6, a size of the first magnet 71 is different from the size of the sixth magnet 614, and the size of the second magnet 72 is different from the size of the seventh magnet 615. This size can be a width dimension, a length dimension, or a height dimension. And in this embodiment, it is the length dimension along the X-axis direction.

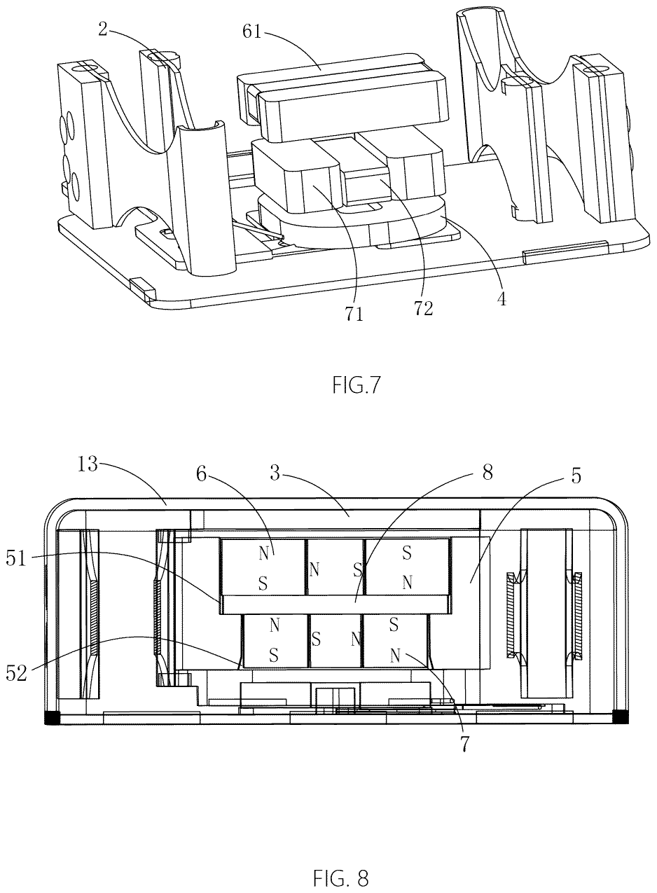

In the fifth embodiment, referring to the FIG. 7, an extension direction of the magnet unit 61 is perpendicular to the extension direction of the first magnets 71, and the first magnets 71 are parallel to the second magnet 72. That is, the magnet unit 61 extends along the X-axis direction, and the extension direction of the first magnet 71 is the same as the extension direction of the second magnet 72.

As a sixth embodiment, referring to the FIG. 8, the linear motor 100 further includes a pole plate 8 between the first magnet assembly 6 and the second magnet assembly 7. The pole plate 8 is connected with the weight 5. The pole plate 8 can be made of both magnetic materials and non-magnetic materials. Magnetic materials include iron cobalt, SPCD steel, 430 steel, etc., while non-magnetic materials include tungsten nickel alloy, 301 stainless steel, 304 stainless steel, etc.

Two ends of the pole plate 8 are welded to the weight 5, or two ends of the pole plate 8 are glued to the weight 5. That is, pole plate 8 and the weight 5 are welded or glued together.

The pole plate 8 locates in the first groove 51, and/or the pole plate locates 8 in the second groove 52. The first magnet assembly 6 is spaced apart from the second magnet assembly 7 through the pole plate 8.

Comparing with the related art, the present invention provides a linear motor includes a housing having a receiving room, a stator accommodated in the receiving room, a vibrator accommodated in the receiving room, and at least one elastic member connected to the housing and suspending the vibrator in the receiving room. The stator is fixedly connected to the housing. The stator includes a coil and a copper sheet. The vibrator includes a weight, a first magnet assembly, and a second magnet assembly. The weight locates between the coil and the copper sheet. The weight includes an upper surface and a lower surface opposite to the upper surface. A part of the upper surface recesses inwardly to form a first groove, and a part of the lower surface recesses inwardly to form a second groove. The first groove is not communicated with the second groove. The first groove is arranged between the copper sheet and the second groove. The first magnet assembly locates in the first groove, the second magnet assembly locates in the second groove. The coil cooperates with the second magnet assembly to drive the vibrator to vibrate along an X-axis direction.

In this way, the first magnet assembly and the second magnet assembly are respectively set in the first groove and the second groove. Removing the pole plate between the first magnet assembly and the copper sheet will directly reduce the gap between the first magnet assembly and the copper sheet. Using smaller volumes of the first magnet assembly and the second magnet assembly can meet the required performance requirements. At the same time, it can improve the utilization rate of the magnetic field, increase the weight of the weight, and achieve overall performance improvement of the linear motor. The linear motor of the present invention has high space utilization and improved the performance.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A linear motor, comprising:
a housing having a receiving room;
a stator accommodated in the receiving room, the stator fixedly connected to the housing, the stator comprising a coil and a copper sheet;
a vibrator accommodated in the receiving room, the vibrator comprising a weight, a first magnet assembly, and a second magnet assembly, the weight located between the coil and the copper sheet, the weight comprising an upper surface and a lower surface opposite to the upper surface, a part of the upper surface recessing inwardly to form a first groove, and a part of the lower surface recessing inwardly to form a second groove, the first groove not communicated with the second groove, the first groove arranged between the copper sheet and the second groove, the first magnet assembly located in the first groove, and the second magnet assembly located in the second groove, the coil cooperating with the second magnet assembly to drive the vibrator to vibrate along an X-axis direction; and
at least one elastic member connected to the housing and suspending the vibrator in the receiving room.

2. The linear motor as described in claim 1, wherein the first magnet assembly comprises at least one magnet unit, and the second magnet assembly comprises two first magnets and one second magnet located between the two first magnets.

3. The linear motor as described in claim 2, wherein the magnet unit comprises one third magnet, the third magnet having two magnetized regions along the X-axis direction, each magnetized region being magnetized along a Y-axis direction, and a magnetization direction of one magnetized region being opposite to a magnetization direction of the other magnetized region.

4. The linear motor as described in claim 2, wherein the magnet unit comprises two fourth magnets, both the fourth magnets being magnetized along a Y-axis direction, and a magnetization direction of one fourth magnet being opposite to a magnetization direction of the other fourth magnet.

5. The linear motor as described in claim 2, wherein the magnet unit comprises five or seven fifth magnets.

6. The linear motor as described in claim 2, wherein the magnet unit comprises two sixth magnets and one seventh magnet located between the two sixth magnets, both the sixth magnets being magnetized along a Y-axis direction, a magnetization direction of one sixth magnet being opposite to the magnetization direction of the other sixth magnet, the seventh magnet being magnetized along the X-axis direction, the two first magnets being magnetized along the Y-axis direction, the magnetization direction of one first magnet being opposite to the magnetization direction of the other first magnet, the second magnet being magnetized along the X-axis direction, the magnetization direction of each first magnet being the same as the magnetization direction of the corresponding sixth magnet, and the magnetization direction of the second magnet being opposite to the magnetization direction of the seventh magnet.

7. The linear motor as described in claim 6, wherein a size of the first magnet is different from the size of the sixth magnet, and the size of the second magnet is different from the size of the seventh magnet.

8. The linear motor as described in claim 1, wherein a size of the first magnet assembly is different from the size of the second magnet assembly.

9. The linear motor as described in claim 2, wherein an extension direction of the magnet unit is perpendicular to the extension direction of the first magnets, and the first magnets are parallel to the second magnet.

10. The linear motor as described in claim 1, wherein the linear motor further comprises a pole plate between the first magnet assembly and the second magnet assembly, the pole plate connected with the weight.

11. The linear motor as described in claim 10, wherein two ends of the pole plate are welded to the weight, or two ends of the pole plate are glued to the weight.

12. The linear motor as described in claim 10, wherein the pole plate locates in the first groove, and/or the pole plate locates in the second groove, the first magnet assembly spaced apart from the second magnet assembly through the pole plate.
